(19) United States
(12) Patent Application Publication
(10) Pub. No.: US 2015/0339650 A1
(43) Pub. Date: Nov. 26, 2015

(54) MERCHANDISE IDENTIFICATION APPARATUS AND METHOD FOR IDENTIFYING MERCHANDISE

(71) Applicants: KABUSHIKI KAISHA TOSHIBA, Tokyo (JP); TOSHIBA TEC KABUSHIKI KAISHA, Tokyo (JP)

(72) Inventor: Akihiro MORO, Nagaizumi (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/286,729

(22) Filed: May 23, 2014

(51) Int. Cl. G06Q 20/20; G06K 9/46; G07G 1/01; G07G 1/00; G07G 1/12

(52) U.S. Cl. CPC G06Q 20/208; G07G 1/0009; G07G 1/12; G07G 1/0036; G07G 1/01; G06K 9/468

(57) ABSTRACT

A merchandise identification apparatus includes an image acquiring unit configured to acquire an image of an item to be purchased by a customer, a controller configured to compare the acquired image with one or more reference images, each being associated with an item on sale, to identify reference images that are similar to the acquired image, and a display unit configured to display one or more items on sale for selection, each of the displayed items being associated with the reference images that are similar to the acquired image. The controller is further configured to cause the acquired image to be associated with an item selected from the one or more of the displayed items.

### FIELD

Embodiments described herein generally relate to a merchandise identification apparatus and a method for identifying merchandise.

### BACKGROUND

A merchandise identification apparatus for identifying an item to be purchased by a customer is known in the art. Such a merchandise identification apparatus is located at a cashier of a store and used by a sales clerk of the store. One type of the merchandise identification apparatus identifies the item to be purchased by object-recognition process, in which an image of the item to be purchased is acquired and the item is identified based on the acquired image. When the item to be purchased cannot be identified by the object-recognition process, the sales clerk needs to manually identify the item to be purchased.

### DESCRIPTION OF THE DRAWINGS

FIG. 1 is a perspective view of an example of a merchandise identification system according to an embodiment.

FIG. 2 is a block diagram illustrating a configuration example of the merchandise identification system according to the embodiment.

FIG. 3 is a conceptual diagram of an example of file according to the embodiment.

FIG. 4 is a block diagram illustrating functional units of a merchandise reader and a POS terminal according to the embodiment.

FIG. 5 is a view of a selection menu which the merchandise reader according to the embodiment displays.

FIG. 6 is a view of a selection result display menu which the merchandise reader according to the embodiment displays.

FIG. 7 is a view of a change ascertainment menu which the merchandise reader according to the embodiment displays.

FIG. 8 is a view of an example of a manipulation image of a purchaser and a sales clerk manipulating the merchandise identification apparatus according to the embodiment.

FIGS. 9A-9C are flow charts of an operational example of merchandise identifying by the merchandise reader according to the embodiment.

FIGS. 10A-10B are flowcharts of an operational example of merchandise candidate processing by the merchandise reader according to the embodiment.

FIG. 11 is a flow chart of an operational example of adding a PLU file by the POS terminal according to the embodiment.

### DETAILED DESCRIPTION

In general, according to one embodiment, a merchandise identification apparatus includes an image acquiring unit configured to acquire an image of an item to be purchased by a customer, a controller configured to compare the acquired image with one or more reference images, each being associated with an item on sale, to identify reference images that are similar to the acquired image, and a display unit configured to display one or more items on sale for selection, each of the displayed items being associated with the reference images that are similar to the acquired image. The controller is further configured to cause the acquired image to be associated with an item selected from the one or more of the displayed items.

Hereinafter, an embodiment will be described with reference to the drawings.

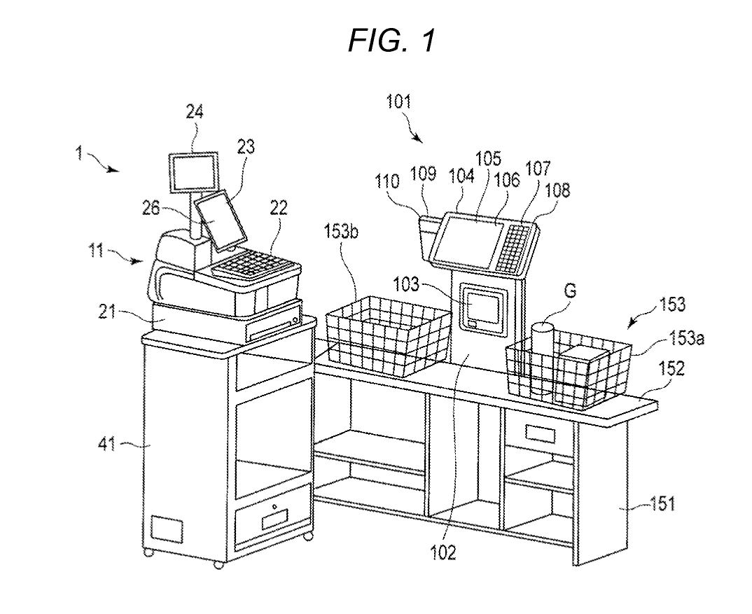

FIG. 1 is a perspective view of a merchandise identification system 1 according to an embodiment.

The merchandise identification system 1 includes a merchandise reader 101 which reads information related to merchandise and a POS terminal 11 which performs registration of the merchandise and settlement on a per transaction basis.

The POS terminal 11 is disposed on a checkout table 41. The POS terminal 11 includes a drawer 21, a keyboard 22, a display device 23 for a sales clerk, a display device 24 for a purchaser (also referred to as a customer), and a touch panel 26 for a sales clerk. The touch panel 26 for a sales clerk faces a sales clerk side of the checkout table 41 and a counter table 151, which are arranged in an L-shape, thereby displaying information for the sales clerk and receiving input of data. The display device 24 for a purchaser is rotatable to face a sales clerk side which is a front side in FIG. 1 or a purchaser side which is a rear side in FIG. 1.

The counter table 151 is disposed to form the L-shape with the checkout table 41. A goods placement surface 152 is an upper surface of the counter table 151. A first shopping basket 153a which a purchaser brings and a second shopping basket 153b placed at a position where the merchandise reader 101 is located between the first shopping basket 153a and the second shopping basket 153b are placed on the goods placement surface 152. An item to be purchased G which a purchaser intends to purchase is put in the first shopping basket 153a.

The merchandise reader 101 is connected to the POS terminal 11 to be able to communicate data therewith, is disposed on the counter table 151. The merchandise reader 101 includes a thin housing 102 of a rectangular shape. The housing 102 has a reading window 103 facing the sales clerk side. A display manipulation unit 104 is disposed on an upper portion of the housing 102. The display manipulation unit 104 includes a display device 105 for a sales clerk, a touch panel 106 for a sales clerk, a keyboard 107, a card-reading groove unit 108, a display device 109 for a purchaser, and a touch panel 110 for a purchaser. The touch panel 106 for a sales clerk faces the sales clerk side of the checkout table 41 and the counter table 151 arranged in the L-shape, and displays information to a sales clerk and receiving inputs. The card-reading groove unit 108 is a groove through which a card reader (not shown in FIG. 1) reads a card.

The display device 109 for a purchaser and the touch panel 110 for a purchaser are on a left rear side of the display manipulation unit 104 in FIG. 1. The display device 109 for a purchaser and the touch panel 110 for a purchaser face a direction opposite to the direction of the touch panel 106 for a sales clerk, and display information to a purchaser and receive inputs.

Subsequently, a configuration example of the merchandise identification system 1 will be described.

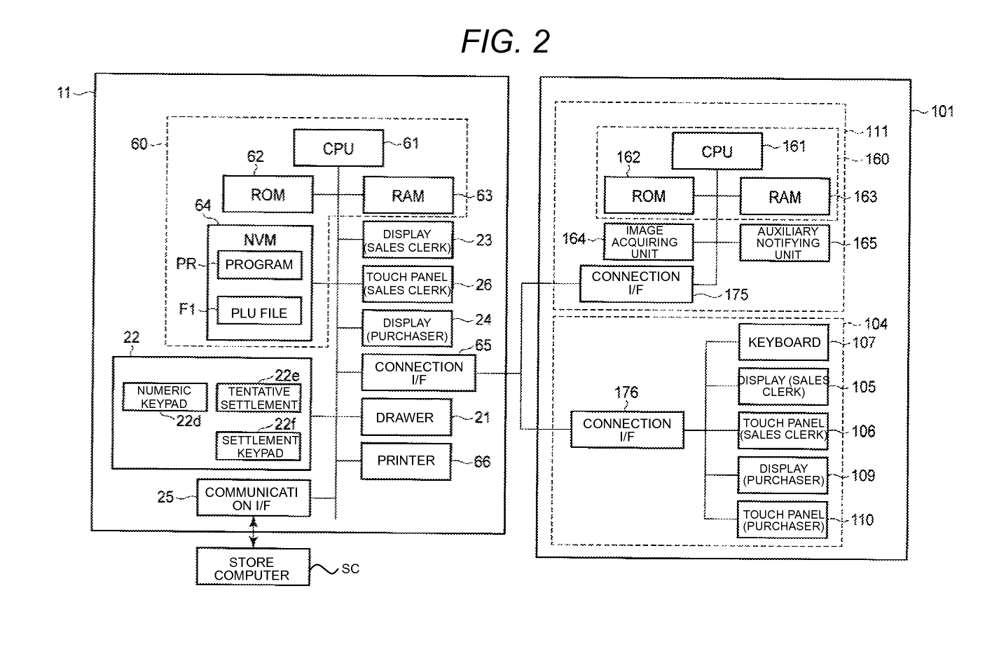

FIG. 2 is a block diagram of a configuration example of the merchandise identification system 1.

As FIG. 2 illustrates, the POS terminal 11 includes a computer 60 as an information processing unit which executes information processing, the drawer 21, the keyboard 22, the display device 23 for a sales clerk, the display device 24 for a purchaser, a communication interface 25, the touch panel 26 for a sales clerk, a connection interface 65, a printer 66, and the like.

The computer 60 includes a central processing unit (CPU) 61, a read only memory (ROM) 62, a random access memory (RAM) 63, and a non-volatile memory (NVM) 64, and the like.

The CPU 61 controls the entire POS terminal 11. The CPU 61 is a processor which performs various types of processing by executing programs. The CPU 61 is connected to each unit inside the POS terminal 11 through a system bus and the like. The CPU 61 controls the drawer 21, the keyboard 22, the display device 24 for a purchaser, the touch panel 26 for a sales clerk, the connection interface 65, the printer 66, and the like.

The ROM 62 is a non-rewritable non-volatile memory which stores programs, control data, and the like.

The RAM 63 includes a volatile memory. The RAM 63 is a working memory or a buffer memory. The CPU 61 performs various types of processing by executing programs and the like stored in the ROM 62 or the NVM 64 while using the RAM 63.

The NVM 64 is a rewritable non-volatile memory, such as a hard disk drive (HDD) and a solid state drive (SSD). The NVM 64 stores a program PR and a price-look-up (PLU) file F1 transmitted from a store computer SC. The program PR is a program to perform various operations of the POS terminal 11. The PLU file F1 will be described later.

The drawer 21 stores cash used in the merchandise identification system 1.

The keyboard 22 is a manipulation unit which receives inputs by a sales clerk. For example, the keyboard 22 includes a numeric keypad 22d, a tentative settlement keypad 22e, a settlement keypad 22f, and the like. The keyboard 22 may be a touch panel or the like.

The display device 23 for a sales clerk is a display unit that displays various types of information to a sales clerk. The display device 23 for a sales clerk is a liquid crystal display and the like, for example.

The display device 24 for a purchaser is a display unit which displays various types of information to a purchaser. The display device 24 for a purchaser is the liquid crystal display and the like, for example.

The touch panel 26 for a sales clerk is an operation unit with which the sales clerk inputs various types of data to the POS terminal 11. Here, the display device 23 for a sales clerk and the touch panel 26 for a sales clerk are integrally formed.

The communication interface 25 is an interface to communicate data with the store computer SC. The communication interface 25 may be an interface of a wire LAN, a wireless LAN, or the like. When the store computer SC is located outside the store, the communication interface 25 may be an interface with which data is transmitted through a communication network such as the internet.

The connection interface 65 is an interface with which data is communicated with the merchandise reader 101. With the connection interface 65, data is communicated with connection interfaces 175 and 176 of the merchandise reader 101.

The printer 66 is a printing unit which prints various images on paper based on a signal from the CPU 61. For example, the printer 66 prints a receipt and the like. The printer 66 adopts an electrophotographic method, an ink-jet method, or the like, for example.

The store computer SC is a host computer which manages the merchandise identification system 1. The store computer SC communicates various types of data with the merchandise identification system 1 in the store or a merchandise identification system in another store. For example, the store computer SC transmits the PLU file F1 to the POS terminal 11.

Subsequently, the merchandise reader 101 will be described.

As FIG. 2 illustrates, the merchandise reader 101 includes a merchandise reading unit 111 and the display manipulation unit 104 and the like.

The merchandise reading unit 111 includes a computer 160, an image acquiring unit 164, an auxiliary notifying unit 165, the connection interface 175, and the like.

The computer 160 includes a central processing unit (CPU) 161, a read only memory (ROM) 162, a random access memory (RAM) 163, and the like.

The CPU 161 controls the entire merchandise reader 101. The CPU 161 is a processor which performs various types of processing by executing programs. The CPU 161 is connected to each unit inside the merchandise reader 101 through a system bus and the like. The CPU 161 controls the image acquiring unit 164, the auxiliary notifying unit 165, the connection interface 175, the display manipulation unit 104 and the like.

The ROM 162 is the non-rewritable non-volatile memory which stores a program, control data and the like.

The RAM 163 includes the volatile memory. The RAM 163 is the working memory or the buffer memory. For example, the RAM 163 retains frame images which the image acquiring unit 164 sequentially acquires (acquired images). The CPU 161 performs various types of processing by executing a program and the like which the ROM 162 or the like stores while using the RAM 163.

The computer 160 may include a non-volatile memory.

The image acquiring unit 164 is an image acquiring unit which acquires a frame image. The image acquiring unit 164 is disposed in the rear side of the reading window 103. For example, the image acquiring unit 164 is a camera such as a color charge coupled device (CCD). The image acquiring unit 164 acquires merchandise in a frame image from the reading window 103 at 30 fps. The image acquiring unit 164 sequentially transmits acquired frame images to the CPU 161.

The auxiliary notifying unit 165 notifies a sales clerk that a purchaser has selected a discounted item. For example, the auxiliary notifying unit 165 gives notification to the sales clerk by an alarm sound, a voice, a vibration, or the like. When the notification is by the alarm sound or the voice, the auxiliary notifying unit 165 may notify the sales clerk by the alarm sound or the voice with an earphone which the sales clerk wears. The auxiliary notifying unit 165 may be a speaker, for example, and may be a device that outputs an electrical audio signal. When the notification is given to the sales clerk by the vibration, the auxiliary notifying unit 165 may cause a vibration device or the like which the sales clerk carries to vibrate.

The connection interface 175 is an interface to communicate data with the POS terminal 11 and the display manipulation unit 104. The CPU 161 causes data to be communicated with the POS terminal 11 and the display manipulation unit 104 through the connection interface 175.

The display manipulation unit 104 includes the keyboard 107, the display device 105 for a sales clerk, the touch panel 106 for a sales clerk, the display device 109 for a purchaser, the touch panel 110 for a purchaser, the connection interface 176, and the like.

The keyboard 107 is an operation unit with which data can be input by a sales clerk. The keyboard 107 may be a touch panel or the like.

The display device 105 for a sales clerk is a display unit which displays various types of information to the sales clerk. The display device 105 for a sales clerk may be a liquid crystal display and the like, for example.

The touch panel 106 for a sales clerk is an operation unit with which the sales clerk inputs various types of data to the merchandise reader 101. Here, the display device 105 for a sales clerk and the touch panel 106 for a sales clerk are integrally formed.

The display device 109 for a purchaser is a display unit that displays various types of information to the purchaser. The display device 109 for a purchaser may be a liquid crystal display and the like, for example.

The touch panel 110 for a purchaser is an operation unit with which the purchaser inputs various types of data to the merchandise reader 101. Here, the display device 109 for a purchaser and the touch panel 110 for a purchaser are integrally formed.

The connection interface 176 is an interface to communicate data between the POS terminal 11 and the merchandise reading unit 111. The connection interface 176 is electrically connected to each unit of the display manipulation unit 104. The CPU 161 and the CPU 61 communicate data with each unit of the display manipulation unit 104 through the connection interface 176.

The POS terminal 11 and the merchandise reader 101 may be a single apparatus.

Subsequently, the PLU file F1 (correlated information) will be described.

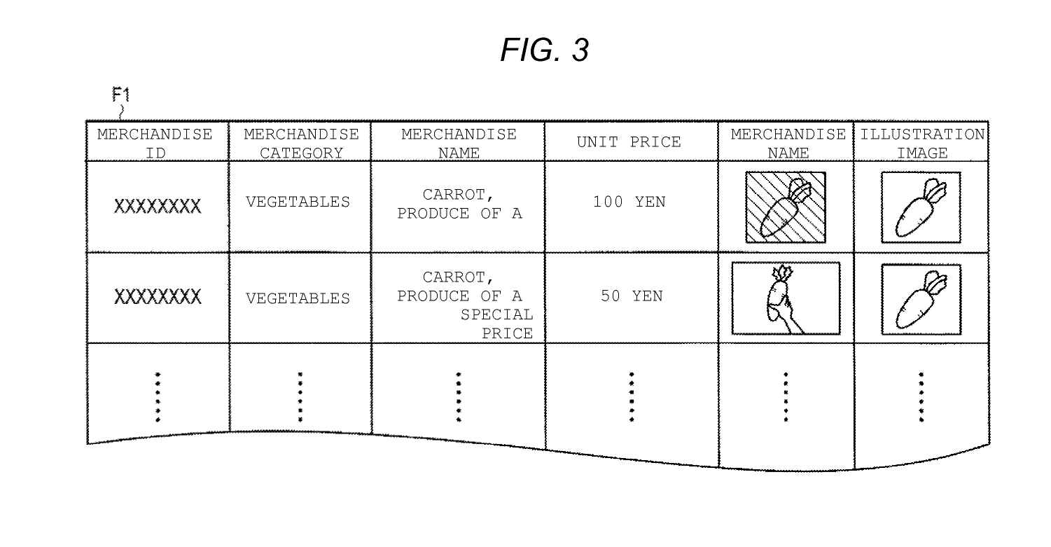

FIG. 3 is a conceptual diagram of the PLU file F1.

The PLU file F1 includes information related to each item on sale, which the POS terminal 11 manages.

Regarding each item on sale, the PLU file F1 stores merchandise information and a acquired image (reference image) of the item that is associated therewith. The merchandise information includes information related to sales of merchandise such as a merchandise ID, a merchandise category, a merchandise name, a unit price, and the like, and an illustration image of the merchandise.

The merchandise ID is an ID which specifies each item on sale. For example, the merchandise ID is a number sequence and the like.

The merchandise category indicates a category to which each item belongs. For example, the merchandise category is “vegetables” and the like.

The merchandise name includes a name of each item and a producing region of the item. Regarding discounted items on sale (low-priced merchandise), the merchandise name further includes information indicating the discount, for example, a “special price”.

The acquired image (reference image) of merchandise is an image obtained by photographing the item. The acquired image is used to determine similarity. The merchandise reader 101 calculates the similarity by comparing the reference image and a frame image including the item to be purchased.

The illustration image is an illustration of the item on sale.

The PLU file F1 may have an additional column to indicate information relating to a discount. The PLU file F1 may store feature values such as color, an unevenness condition of a surface, and the like which are read from the acquired reference image.

The configuration of the PLU file F1 is not limited to a particular configuration.

The PLU file F1 is stored in the NVM 64 in advance. For example, the POS terminal 11 receives the PLU file F1 from the store computer SC in advance, thereby storing the received PLU file F1 in the NVM 64.

Subsequently, functions of the POS terminal 11 and the merchandise reader 101 will be described.

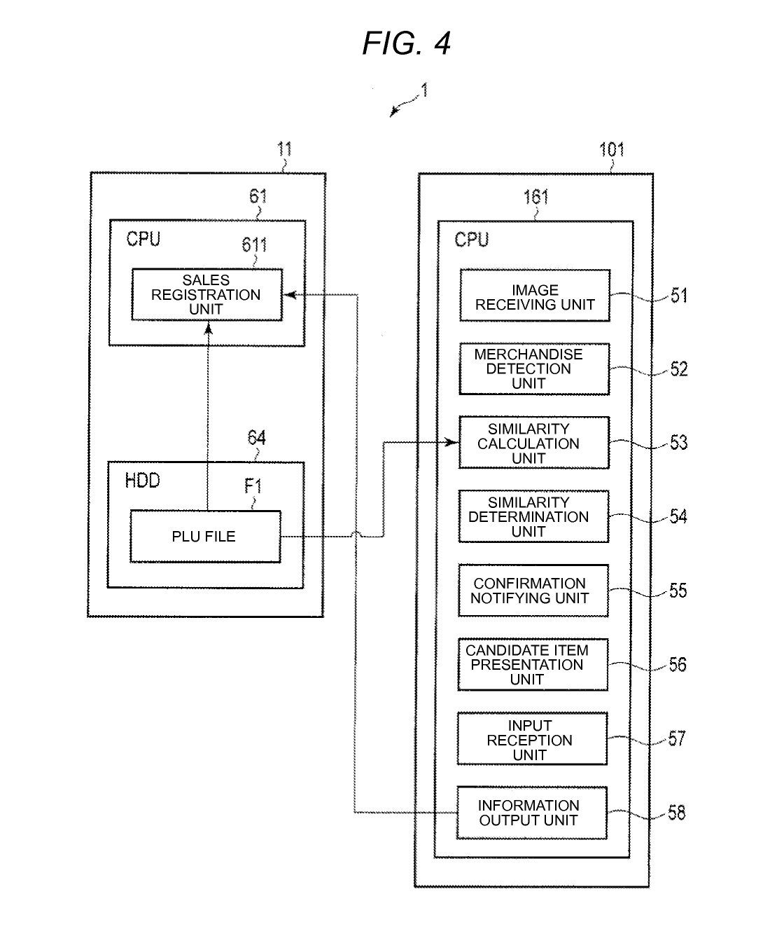

FIG. 4 is a block diagram illustrating a functional units of the POS terminal 11 and the merchandise reader 101.

The CPU 161 of the merchandise reading unit 111 includes an image receiving unit 51, a merchandise detection unit 52, a similarity calculation unit 53, a similarity determination unit 54, a confirmation notifying unit 55, a merchandise candidate presentation unit 56, an input reception unit 57, and an information output unit 58.

For example, the CPU 161 performs various functions by executing programs stored in the ROM 162.

The image receiving unit 51 acquires a frame image including the item to be purchased which the image acquiring unit 164 acquires. The image receiving unit 51 may cause the acquired frame image to be stored in the RAM 163 and the like.

The merchandise detection unit 52 entirely or partially detects purchase merchandise included in the frame image which the image receiving unit 51 receives using a pattern matching technology and the like.

For example, the merchandise detection unit 52 extracts an outline and the like of the item to be purchased from a binarized image of the acquired frame image. After extracting the outline and the like, the merchandise detection unit 52 compares outlines, which have been extracted from the image including items on sale in advance, and the outline extracted from the acquired frame image, and searches items on sale that correspond to the item to be purchased.

The similarity calculation unit 53 calculates the similarity between the item to be purchased, which the image acquiring unit 164 acquires, and each item on sale registered in the PLU file F1.

For example, the similarity calculation unit 53 reads color, a state of a surface such as an unevenness condition of a surface, and the like of the item to be purchased as feature values from a frame image including the item. After reading the feature values, the similarity calculation unit 53 compares the read feature values and the feature values of the items on sale in the PLU file F1. The similarity calculation unit 53 compares both of the feature values, thereby calculating the similarity between the item to be purchased included in the frame image and the items on sale in the PLU file F1. The similarity indicates a degree of the similarity between the item to be purchased included in the frame image and the items on sale in the PLU file F1. A similarity of 100% may be expressed as similarity: 1.0.

The similarity calculation unit 53 calculates the similarity between the item to be purchased and each item on sale in the PLU file F1.

A method of calculating the similarity by the similarity calculation unit 53 is not limited to a particular method.

The similarity determination unit 54 (extraction unit) determines whether the similarity which the similarity calculation unit 53 calculates fulfills a predetermined condition. Here, the similarity determination unit 54 determines whether 90%≦similarity is fulfilled, whether 75%≦similarity<90% is fulfilled, and whether 10%≦similarity<75% is fulfilled. The similarity determination unit 54 extracts candidate items of which similarity fulfill 10%≦similarity<75% from the items on sale merchandise registered in the PLU file.

The confirmation notifying unit 55 notifies a sales clerk and a purchaser that the item to be purchased included in the frame image is confirmed. For example, when the item to be purchased is confirmed, the confirmation notifying unit 55 displays a confirmation notification image indicating the confirmation of purchase of the item on the display device 105 for a sales clerk and the display device 109 for a purchaser.

When there is a plurality of candidate items with respect to the item to be purchased, the merchandise candidate presentation unit 56 causes the plurality of candidate items to presented to a sales clerk or a purchaser. When the plurality of candidate items are presented to a sales clerk, the merchandise candidate presentation unit 56 causes a selection menu including the plurality of candidate items to be displayed on the display device 105 for a sales clerk. When the plurality of candidate items are presented to a purchaser, the merchandise candidate presentation unit 56 causes the selection menu including the plurality of candidate items to be displayed on the display device 109 for a purchaser. The merchandise candidate presentation unit 56 may cause the name of the candidate item, an image of the candidate item, or both to be presented.

The input reception unit 57 recognizes inputs of data to the keyboard 107, the touch panel 106 for a sales clerk, and the touch panel 110 for a purchaser. For example, the input reception unit 57 recognizes inputs indicating that the sales clerk confirms the purchase, that the sales clerk selects the item to be purchased among the plurality of candidate items, and the like, with the touch panel 106 or the keyboard 107. The input reception unit 57 recognizes inputs indicating that the purchaser selects the item to be purchased among the plurality of candidate items with the touch panel 110.

The information output unit 58 outputs a merchandise ID of the confirmed item to the POS terminal 11 as a merchandise ID of the item to be purchased.

The CPU 61 of the POS terminal 11 includes a sales registration unit 611 and the like.

For example, the CPU 61 performs a function by executing a program stored in the ROM 162 stores or the program PR stored in the NVM 64.

The sales registration unit 611 registers the sale of an item based on a merchandise ID (and the number of the item) which the information output unit 58 outputs. The sales registration unit 611 records an output merchandise ID, a merchandise category corresponding to the merchandise ID, a merchandise name, a unit price, and the like (together with the number of the item) on a sales master file and the like with reference to the PLU file F1, thereby registering the sales.

Subsequently, the selection menu to select the item to be purchased among a plurality of candidate items will be described.

The selection menu is a menu screen with which a sales clerk or a purchaser selects the item to be purchased among a plurality of candidate items.

When a sales clerk carries out the selection, the merchandise reader 101 displays the selection menu on the display device 105 for a sales clerk. When a purchaser carries out the selection, the merchandise reader 101 displays the selection menu on the display device 109 for a purchaser.

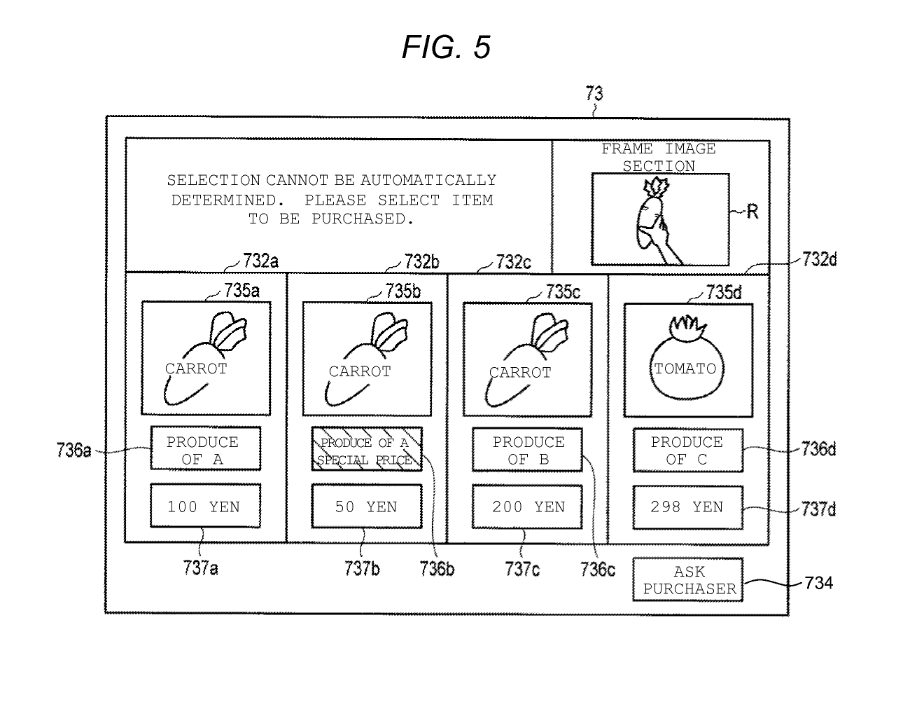

FIG. 5 illustrates an example of a selection menu 73.

The selection menu 73 includes a frame image section R, information display sections 732a to 732d, and the like.

In the frame image section R, the acquired frame image is displayed. Thus, in the frame image section R, the item to be purchased is displayed.

In an information display section 732, candidate items are displayed. Here, in the information display section 732, images of candidate items are displayed in an order of descending similarity from left to right. Images in the information display sections 732a to 732d are displayed in a selectable manner.

The information display section 732 includes an illustration image section 735, a producing district display section 736, a charge amount display section 737, and the like.

In the illustration image section 735, an image in which an illustration image of the candidate item and the merchandise name of the candidate item are overlapped is displayed.

In the producing district display section 736, a producing region of the candidate item is displayed. When a merchandise name section of the PLU file F1 includes discount information such as a special price and the like, the discount information is also displayed in the producing district display section 736.

For example, information indicating that discount is offered is displayed in a producing region display section 736b in addition to the producing region. Information displayed in the producing region display section 736b is emphasized by changing color thereof and the like to attract attention.

In the charge amount display section 737, a charge amount of the candidate item is displayed.

In FIG. 5, as an example, the information display sections 732a to 732d respectively indicate items a to d.

In the information display section 732a in which the item a is displayed, the selection menu 73 shows an image of a carrot in an illustration image section 735a, “produce of A” in a producing district display section 736a, and “100 yen” in a charge amount display section 737a.

In the information display section 732b, the selection menu 73 shows the image of the carrot in an illustration image section 735b, “produce of A” and “special price” in the producing district display section 736b, and “50 yen” in a charge amount display section 737b.

In the information display section 732c, the selection menu 73 shows the image of the carrot in an illustration image section 735c, “produce of B” in a producing district display section 736c, and “200 yen” in a charge amount display section 737c.

In the information display section 732d, the selection menu 73 shows an image of a tomato in an illustration image section 735d, “produce of C” in a producing district display section 736d, and “298 yen” in a charge amount display section 737d.

The information display sections 732a to 732d also are icons for selecting the item to be purchased among the candidate items. The sales clerk or the purchaser touches any one of regions of the information display sections 732a to 732d, thereby selecting one of the candidate items corresponding to the touched region.

When the selection menu 73 is displayed on the display device 105 for a sales clerk, the selection menu 73 includes a selection request icon 734. The selection request icon 734 is an icon for the sales clerk to request the purchaser sales clerk to select one item that corresponds to the item to be purchased from the displayed candidate items.

Subsequently, a selection result display menu will be described.

The selection result display menu is a menu to check whether the selection of the purchaser is appropriate.

The merchandise reader 101 displays the selection result display menu on the display device 105 for a sales clerk after the purchaser selects one item from the displayed candidate items.

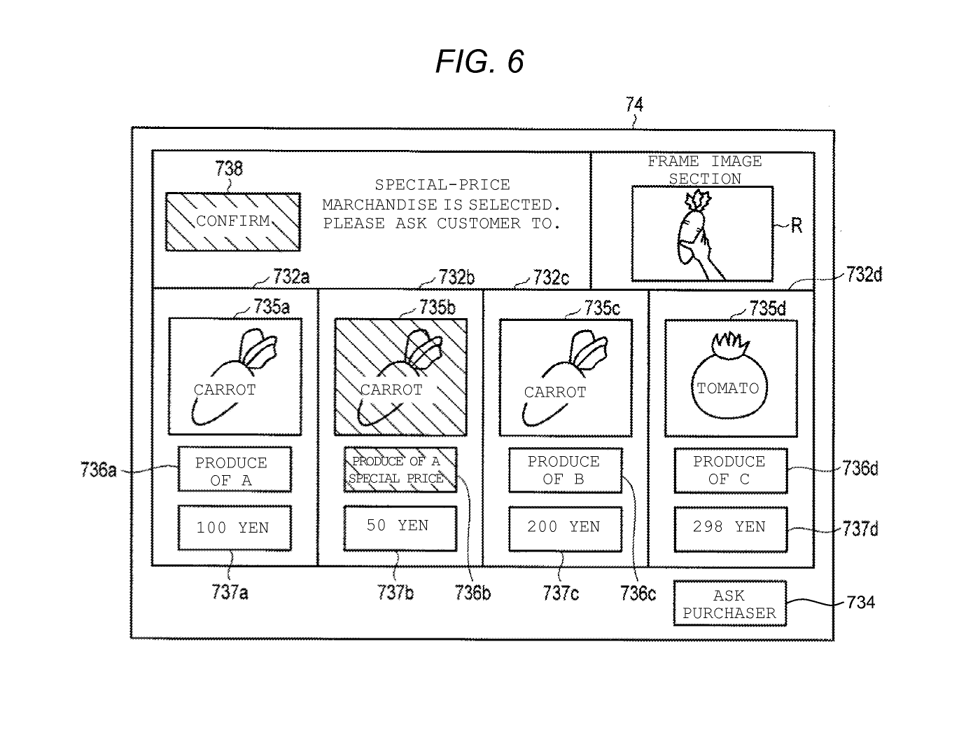

FIG. 6 illustrates an example of a selection result display menu 74.

The selection result display menu 74 is different from the selection menu 73 in the color of the illustration image section 735b and in the point of including a confirmation icon 738. Therefore, the same reference numerals and signs will be applied to other configurations, thereby omitting detailed descriptions.

Here, the purchaser is assumed to select the item b displayed in the information display section 732b.

As FIG. 6 illustrates, the illustration image section 735b of the information display section 732b is changed in color to indicate that the purchaser selects the item b.

The other sections (for example, charge amount display section 737b or the like) of the information display section 732b may be changed in color. A character string indicating that the purchaser selects the item b of merchandise may be displayed in the information display section 732b. The merchandise reader 101 may display information indicating that the purchaser selects the item b in a section other than the information display section 732b.

The confirmation icon 738 is an icon for the sales clerk to confirm that the selection of the purchaser is appropriate. When the selection of the purchaser is determined to be appropriate, the sales clerk touches the confirmation icon 738, thereby confirming the purchase of the selected item.

Subsequently, the selected item change menu will be described.

The selected item change menu is a menu with which the sales clerk changes the selected item to an appropriate item when the purchaser selects an incorrect item.

The merchandise reader 101 displays the change confirmation menu when the sales clerk selects on the selection result display menu 74 an item that is different from the item selected by the customer. In the selection result display menu 74, the sales clerk touches the information display section 732 indicating an item other than the item selected by the purchaser, thereby selecting an appropriate item.

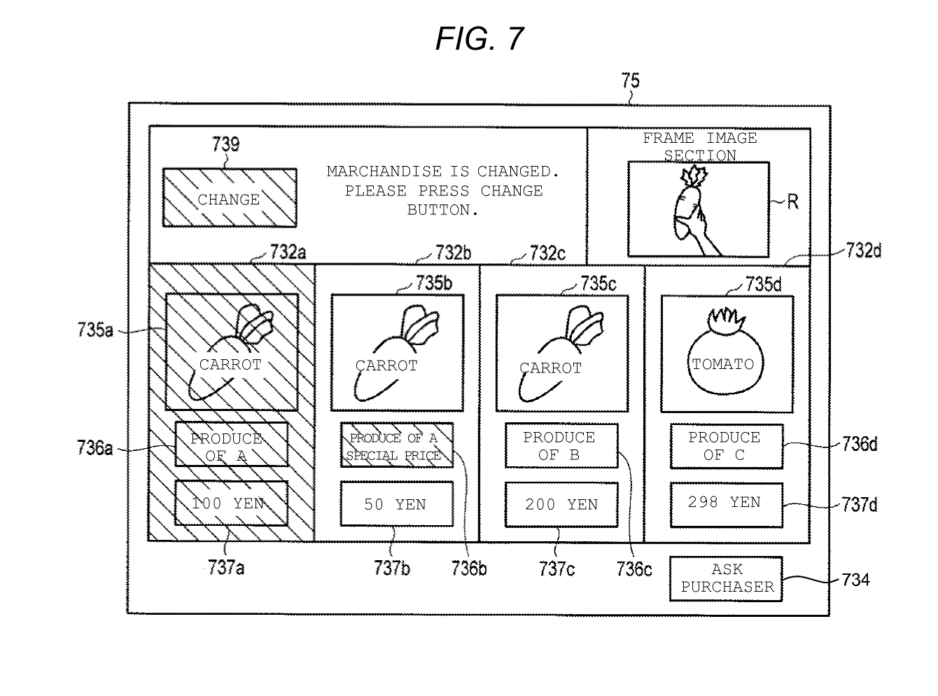

FIG. 7 illustrates, as an example, a selected item change menu 75.

The selected item change menu 75 is different from the selection menu 73 in the color of the information display section 732a and in the point of including a change icon 739. Therefore, the same reference numerals and signs will be applied to other configurations, thereby omitting detailed descriptions.

Here, the sales clerk is assumed to select an item a displayed in the information display section 732a.

As FIG. 7 illustrates, the information display section 732a changes its color to indicate that the sales clerk selects the item a.

The other sections (for example, illustration image section 735a or the like) of the information display section 732a may be changed in color. A character string indicating that the sales clerk selects the item b may be displayed in the information display section 732a. The merchandise reader 101 may display information indicating that the sales clerk selects the item a in a section other than the information display section 732a.

A change icon 739 is an icon for the sales clerk to confirm the item selected by the sales clerk. The sales clerk touches the change icon 739, thereby confirming the item to be purchased.

Subsequently, purchase processing through the merchandise identification system 1 will be described.

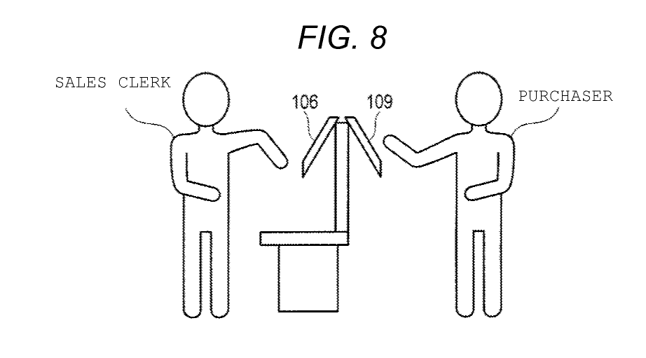

FIG. 8 illustrates an example of an image in which a purchaser and a sales clerk operate the merchandise identification system 1.

Here, the purchaser is considered to purchase the item G. The purchaser is assumed to put the merchandise G into the first shopping basket 153a, thereby carrying the basket to the merchandise identification system 1.

Firstly, the sales clerk takes the item G, which the purchaser intends to purchase, out from the first shopping basket 153a so as to face the reading window 103, thereby causing the image acquiring unit 164 to acquire an image of the item G. When the image of the item G is acquired, the sales clerk moves the item G into the second shopping basket 153b.

The merchandise reader 101 acquires a frame image including the item G with the image acquiring unit 164. When the frame image is acquired, the merchandise reader 101 extracts one or more candidate items, which are candidates for the item G, based on the PLU file F1. Here, the merchandise reader 101 is assumed to extract a plurality of candidate items.

When the plurality of candidate items are extracted, the merchandise reader 101 displays the selection menu 73, from which a candidate item corresponding to the item G is selected from the plurality of extracted candidate items, on the display device 105 for a sales clerk. When the sales clerk can select the item, the sales clerk selects the item through the touch panel 106 for a sales clerk.

When the sales clerk does not select the item, the sales clerk touches the selection request icon 734. When the sales clerk touches the selection request icon 734, the merchandise reader 101 displays the selection menu 73 on the display device 109 to prompt the purchaser to select one item corresponding to the item G.

The purchaser selects one item corresponding to the item G from the plurality of candidate items through the touch panel 110 for a purchaser.

When the purchaser selects the item, the merchandise reader 101 displays the selection result display menu 74 on the display device 105 for a sales clerk so that the sales clerk can confirm that the item selected by the purchaser is appropriate.

When the item which the purchaser selects is a discounted item, the merchandise reader 101 displays the selection result display menu 74 and causes the confirmation icon 738 and the illustration image section 735 of the selected item to flash, thereby notifying of the sales clerk that the purchaser is selecting the discounted item. The merchandise reader 101 calls attention of the sales clerk by a voice message through an earphone of the sales clerk, a vibration, or the like.

Here, the purchaser is assumed to select a discounted item.

The sales clerk asks orally or the like to the purchaser whether the selection of the discounted item is appropriate. The sales clerk may ask another sales clerk about whether the selection by the purchaser is appropriate.

When the selection by the purchaser is appropriate, the sales clerk touches the confirmation icon 738, thereby confirming that the item selected by the purchaser corresponds to the item G. When the sales clerk confirms that the item selected by the purchaser corresponds to the item G, the merchandise reader 101 causes the acquired image of the item G to be correlated with the merchandise ID of the item selected by the purchaser, and transmits them to the POS terminal 11 as additional information to be added to the PLU file F1. The merchandise reader 101 outputs a merchandise ID of the item selected by the purchaser to the POS terminal 11 as the merchandise ID of the item G.

When the selection by the purchaser is not appropriate, the sales clerk touches the information display section 732 indicating an item corresponding to the item G, thereby selecting appropriate item. When the sales clerk selects the appropriate item, the merchandise reader 101 displays the selected item change menu 75 on the display device 105 for a sales clerk to confirm the selection by the sales clerk. Simultaneously, the merchandise reader 101 displays the item selected by the sales clerk on the display device 109 for a purchaser.

When the selection by the sales clerk is appropriate, the sales clerk touches the change icon 739, thereby confirming that the item selected by the sales clerk is the item. G. When the selection by the sales clerk is not appropriate, the sales clerk touches the information display section 732 indicating an appropriate item, thereby selecting the appropriate item from the candidate items.

When the sales clerk confirms that the selected item is the item G, the merchandise reader 101 causes the acquired image of the item G to be correlated with a merchandise ID of the item selected by the sales clerk, and transmits them to the POS terminal 11 as additional information to be added to the PLU file F1. The merchandise reader 101 outputs the merchandise ID of the item by the sales clerk to the POS terminal 11 as the merchandise ID of the item G.

When the POS terminal 11 receives the additional information from the merchandise reader 101, the POS terminal 11 adds the additional information to the PLU file F1. The POS terminal 11 may add also merchandise information corresponding to the item indicated by the additional information when it adds the additional information to the PLU file F1.

In addition, the POS terminal 11 receives a merchandise ID of the item G from the merchandise reader 101. When the merchandise ID of the item G is received, the POS terminal 11 records information related in sales registration such as a merchandise category of the item corresponding to the merchandise ID, the merchandise name, and a unit price, on a sales master file based on the received merchandise ID, thereby performing the sales registration.

When the POS terminal 11 finishes the sales registration, the purchase processing for the item G ends. When the purchaser intends to purchase a plurality of items, the above-described purchase processing is repeated a plurality of times.

Subsequently, an operational example of the merchandise reader 101 will be described.

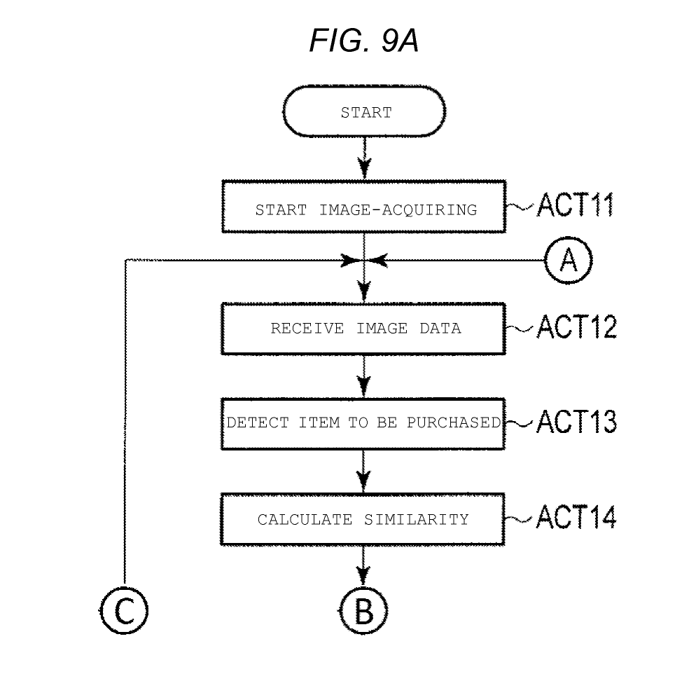

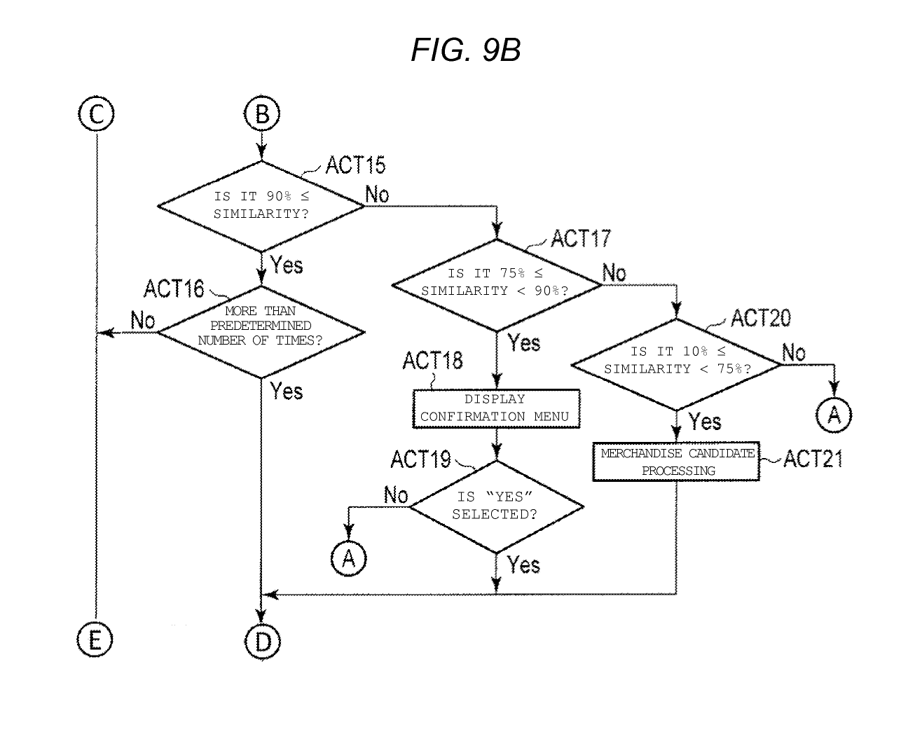

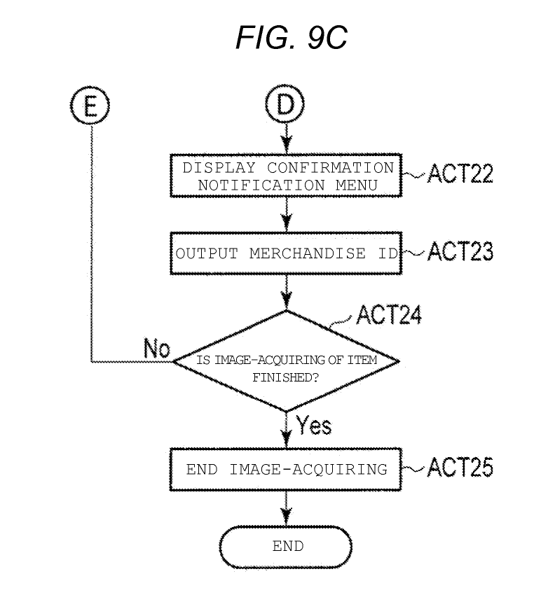

FIGS. 9A to 9C are flow charts of an operational example of the merchandise reader 101.

Here, a sales clerk is assumed to start the merchandise identifying process by manipulating the keyboard 107 and the like.

First, the CPU 161 of the merchandise reader 101 transmits a signal to the image acquiring unit 164, thereby causing the image acquiring unit 164 to start acquiring a frame image (ACT 11).

When the image acquiring unit 164 acquires the frame image, the image receiving unit 51 of the CPU 161 receives the frame image from the image acquiring unit 164 (ACT 12).

When the image receiving unit 51 receives the frame image, the merchandise detection unit 52 detects the item to be purchased (item G) from the frame image (ACT 13). For example, the merchandise detection unit 52 extracts an outline of the item G from the frame image.

When the merchandise detection unit 52 extracts an outline of the item G, the similarity calculation unit 53 calculates the similarity of the item G and each item on sale included in the PLU file F1 (ACT 14).

When the similarity of the item G and each item of merchandise which the PLU file F1 stores is calculated, the similarity determination unit 54 determines whether there is an item on sale that satisfies 90%≦similarity (ACT 15). When the similarity determination unit 54 determines that there is such an item on sale (ACT 15, YES), the CPU 161 determines whether the condition of 90%≦similarity is fulfilled with respect to the item on sale for a predetermined number of times (ACT 16).

When the similarity determination unit 54 determines that there is no item on sale that satisfies 90%≦similarity (ACT 15, NO), the similarity determination unit 54 determines whether there is an item on sale that satisfies 75%≦similarity<90% (ACT 17). When the similarity determination unit 54 determines that there is such an item (ACT 17, YES), the CPU 161 causes a confirmation menu to confirm that the item G corresponds to the item of 75%≦similarity<90% to be displayed on the display device 105 for a sales clerk (ACT 18). When the CPU 161 displays the confirmation menu, the input reception unit 57 determines whether a sales clerk selects “YES” in the confirmation menu (ACT 19).

When the similarity determination unit 54 determines that there is no item on sale of 75%≦similarity<90% (ACT 17, NO), the similarity determination unit 54 determines whether there is an item on sale that satisfies 10%≦similarity<75% (ACT 20). When the similarity determination unit 54 determines that there is such an item (ACT 20, YES), the CPU 161 performs the merchandise candidate processing (ACT 21). The merchandise candidate processing will be described later.

When the CPU 161 determines that the condition of 90%≦similarity is fulfilled with respect to an item on sale for the predetermined number of times (ACT 16, YES), when the input reception unit 57 determines that a sales clerk selects “YES” in the confirmation menu (ACT 19, YES), or when the CPU 161 performs the merchandise candidate processing (ACT 21), the confirmation notifying unit 55 causes the confirmation notification image indicating the confirmed item to be displayed on the display device 105 for a sales clerk and the display device 109 for a purchaser (ACT 22).

When the confirmation notifying unit 55 causes the confirmation notification image to be displayed, the information output unit 58 outputs a merchandise ID of the confirmed item to the POS terminal 11 as a merchandise ID indicating the item included in the frame image (ACT 23).

When the information output unit 58 outputs the merchandise ID to the POS terminal 11, the CPU 161 determines whether image-acquiring of the item is finished (ACT 24). For example, the CPU 161 determines whether an input instructing to end the image-acquiring is made by the sales clerk.

When the CPU 161 determines that the condition of 90%≦similarity is not fulfilled by the item on sale for the predetermined number of times (ACT 16, NO), when the input reception unit 57 determines that the sales clerk selects “NO” in the confirmation menu (ACT 19, NO), when the similarity determination unit 54 determines that there is no item that satisfies 10%≦similarity<75% (ACT 20, NO), and when the CPU 161 determines that the image-acquiring of the item is not finished (ACT 24, NO), the CPU 161 returns to ACT 12.

When the image-acquiring of the item G is determined to be finished (ACT 24, YES), the CPU 161 transmits a signal to the image acquiring unit 164, thereby causing the image acquiring unit 164 to end the image-acquiring of a frame image (ACT 25). When the image acquiring unit 164 ends the image-acquiring of the frame image, the CPU 161 ends the operation.

Subsequently, the merchandise candidate processing (ACT 21) will be described.

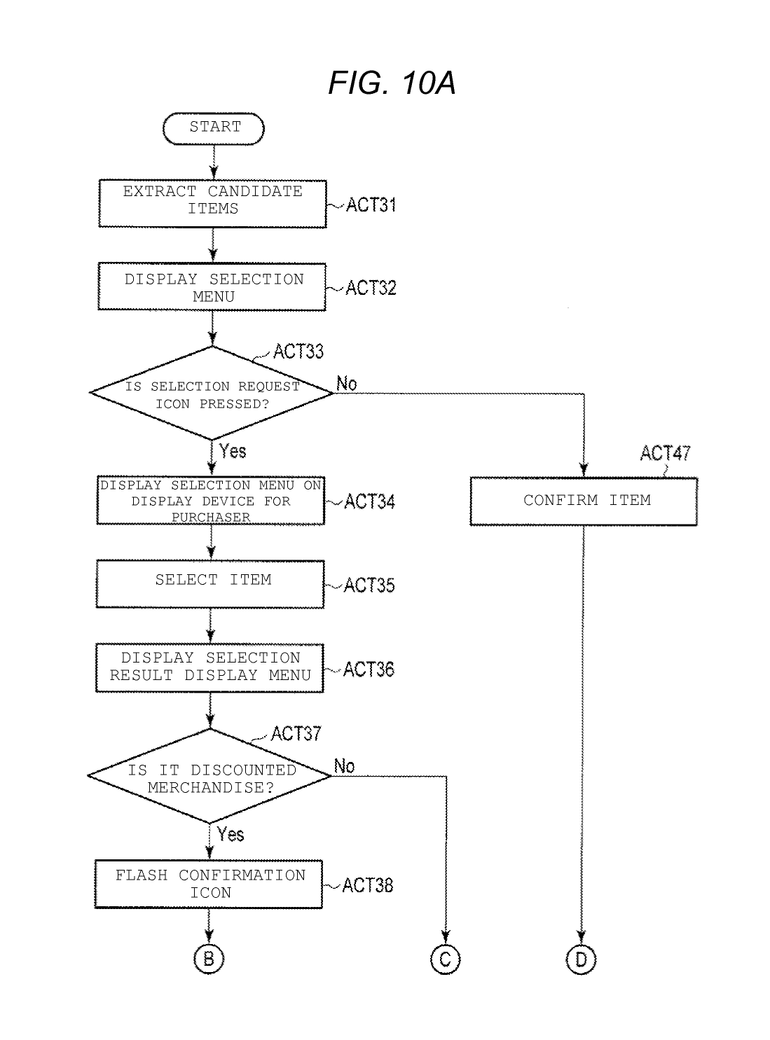

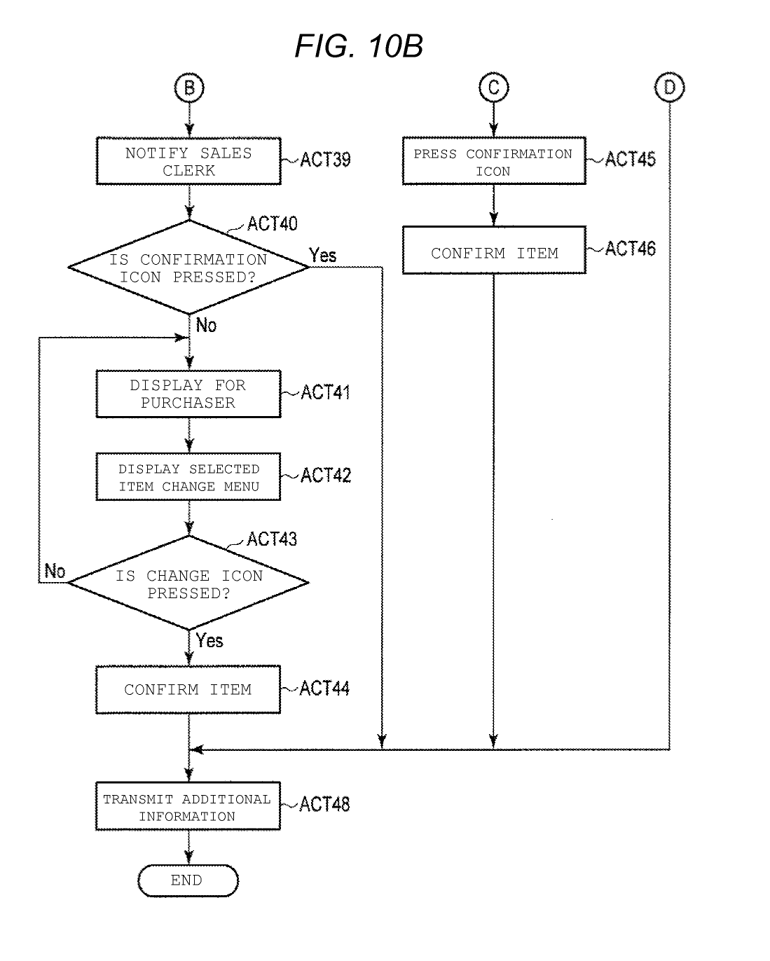

FIGS. 10A and 10B are flowcharts of an operation example of the merchandise candidate processing.

Here, it is assumed that there are a plurality of candidate items.

First, the similarity determination unit 54 of the CPU 161 extracts candidate items from the PLU file F1 (ACT 31).

When the similarity determination unit 54 extracts candidate items, the merchandise candidate presentation unit 56 causes the selection menu 73 to be displayed on the display device 105 for a sales clerk (ACT 32).

When the merchandise candidate presentation unit 56 causes the selection menu 73 to be displayed on the display device 105 for a sales clerk, the input reception unit 57 determines whether the selection request icon 734 is pressed (touched) by the sales clerk (ACT 33). When the input reception unit 57 determines that the selection request icon 734 is pressed by the sales clerk (ACT 33, YES), the merchandise candidate presentation unit 56 causes the selection menu 73 to be displayed on the display device 109 for a purchaser (ACT 34).

When the selection menu 73 is displayed on the display device 109 for a purchaser, the input reception unit 57 receives a selection input indicating that the purchaser selects one item corresponding to the item. G from the candidate items (ACT 35). When the selection input by the purchaser is received, the CPU 161 causes the selection result display menu 74 to be displayed on the display device 105 for a sales clerk (ACT 36).

When the selection result display menu 74 is displayed, the CPU 161 determines whether a discounted merchandise is selected by the purchaser (ACT 37). When the discounted merchandise is determined to be selected by the purchaser (ACT 37, YES), the CPU 161 causes the confirmation icon and the illustration image section 735 of the selected item to flash (ACT 38). When the confirmation icon and the illustration image section 735 are caused to flash, the CPU 161 controls the auxiliary notifying unit 165 to generate a voice or a vibration so as to notify the sales clerk that the discounted merchandise is selected by the purchaser (ACT 39). ACT 38 and ACT 39 may be reversed in order, or may proceed concurrently.

When the CPU 161 causes the notification to be generated, the input reception unit 57 determines whether the confirmation icon 738 is pressed by the sales clerk (ACT 40). When the input reception unit 57 determines that the confirmation icon 738 is not pressed by the sales clerk (ACT 40, NO), that is, when it is determined that the different item is selected by the sales clerk, the CPU 161 causes the item selected by the sales clerk to be displayed on the display device 109 for a purchaser (ACT 41).

When the item selected by the sales clerk is displayed on the display device 109 for a purchaser, the CPU 161 causes the selected item change menu 75 on the display device 105 for a sales clerk (ACT 42). When the selected item change menu 75 is displayed, the input reception unit 57 determines whether the change icon 739 is pressed by the sales clerk (ACT 43).

When the input reception unit 57 determines that the change icon 739 is not pressed by the sales clerk (ACT 43, NO), that is, another item is reselected by the sales clerk, the CPU 161 returns to ACT 41.

When the input reception unit 57 determines that the change icon 739 is pressed by the sales clerk (ACT 43, YES), the CPU 161 determines that the item selected by the sales clerk is the item G (ACT 44).

When the CPU 161 determines that a discounted item is not selected by the purchaser (ACT 37, NO), the input reception unit 57 receives pressing of the confirmation icon 738 (ACT 45). When the input reception unit 57 receives the pressing of the confirmation icon 738, the CPU 161 determines that the item selected by the purchaser is the item G (ACT 46).

When the input reception unit 57 determines that the selection request icon 734 is not pressed by the sales clerk (ACT 33, NO), the CPU 161 determines that the item selected by the sales clerk is the item G (ACT 47).

When the item reselected by the sales clerk is determined to be the item G (ACT 44), when the item selected by the purchaser is determined to be the item G (ACT 46), or when the item selected by the sales clerk is confirmed to be the item G (ACT 47), the CPU 161 causes a merchandise ID of the item, which is confirmed to be the item G to be correlated with an image of the item G, and transmits them to the POS terminal 11 through the connection interface 176 as additional information (ACT 48).

When the additional information is transmitted to the POS terminal 11, the CPU 161 ends the merchandise candidate processing.

Subsequently, an operation of the POS terminal 11 adding additional information to the PLU file will be described.

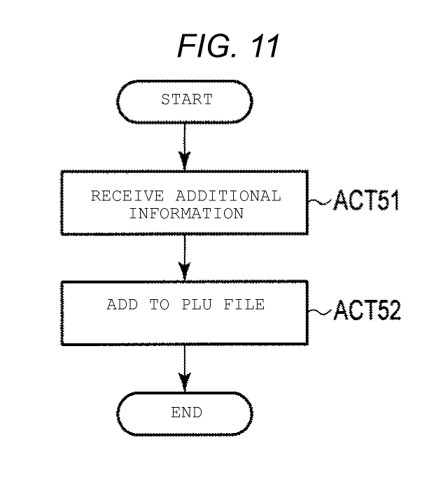

FIG. 11 is a flow chart of an operational example in which the POS terminal 11 adds the additional information to the PLU file.

First, the CPU 61 of the POS terminal 11 receives the additional information from the merchandise reader 101 through the connection interface 65 (ACT 51).

When the additional information is received from the merchandise reader 101, the CPU 61 adds the additional information to the PLU file F1 which the NVM 64 stores (ACT 52). The CPU 61 may add also merchandise information corresponding to the item which the additional information indicates.

When the additional information is added to the PLU file F1, the CPU 61 ends the operation.

The merchandise reader which is configured as above may cause a merchandise ID of an item selected by a purchaser and a merchandise image of the merchandise, to correlate with each other. The POS terminal may add new data to a PLU file based on information which the merchandise reader outputs. As a result, the merchandise identification system improves the recognition rate when object-recognition process is performed on the same item in the future, and thus, there may be no need to ask a purchaser for selecting the item from the candidate items in the future. Therefore, the merchandise identification system may efficiently identify the item to be purchased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A merchandise identification apparatus comprising:
an image acquiring unit configured to acquire an image of an item to be purchased by a customer;
a controller configured to compare the acquired image with one or more reference images, each being associated with an item on sale, to identify reference images that are similar to the acquired image; and
a display unit configured to display one or more items on sale for selection, each of the displayed items being associated with the reference images that are similar to the acquired image,
wherein the controller is further configured to cause the acquired image to be associated with an item selected from the one or more of the displayed items.

2. The merchandise identification apparatus according to claim 1, further comprising:
an operation unit configured to receive an input by a sales clerk that confirms that the selected item corresponds to the item to be purchased.

3. The merchandise identification apparatus according to claim 1, further comprising:
an operation unit configured to receive an input by a sales clerk that instructs the display unit to display the one or more items on sale,
wherein the display unit is configured to display the one or more items on sale in response to the input.

4. The merchandise identification apparatus according to claim 1, further comprising:
an operation unit configured to receive a selection by the customer of one of the displayed items.

5. The merchandise identification apparatus according to claim 4, further comprising:
a notifying unit configured to notify a sales clerk that the item selected by the customer is a predetermined item.

6. The merchandise identification apparatus according to claim 5, wherein
the predetermined item is a discounted item.

7. The merchandise identification apparatus according to claim 1, further comprising:
an operation unit configured to receive a selection by a sales clerk of one of the displayed items.

8. A system comprising:
a sales data processing apparatus including a storage unit configured to store data of items on sale together with associated reference images; and
a merchandise identification apparatus including an image acquiring unit configured to acquire an image of an item to be purchased by a customer, a controller configured to compare the acquired image with one or more of the stored reference images to identify reference images that are similar to the acquired image, and a display unit configured to display one or more items on sale for selection, each of the displayed items being associated with the reference images that are similar to the acquired image,
wherein the controller is further configured to cause the acquired image to be stored in the storage unit as one of the reference images associated with an item selected from the one or more of the displayed items.

9. The system according to claim 8, wherein
one of the sales data processing apparatus and the merchandise identification apparatus further comprises an operation unit configured to receive an input by a sales clerk that confirms that the selected item corresponds to the item to be purchased.

10. The system according to claim 8, wherein
an operation unit configured to receive an input by a sales clerk that instructs the display unit to display the one or more items on sale,
wherein the display unit is configured to display the one or more items on sale in response to the input.

11. The system according to claim 8, wherein
the merchandise identification apparatus further comprises an operation unit configured to receive a selection by the customer of one of the displayed items.

12. The system according to claim 11, wherein
one of the sales data processing apparatus and the merchandise identification apparatus further comprises a notifying unit configured to notify a sales clerk that the item selected by the customer is a predetermined item.

13. The system according to claim 12, wherein
the predetermined item is a discounted item.

14. A method for identifying merchandise comprising:
storing data of items on sale together with associated reference images;
acquiring an image of an item to be purchased by a customer;
comparing the acquired image with one or more of the stored reference images to identify reference images that are similar to the acquired image;
displaying one or more items on sale for selection, each of the displayed items being associated with the reference images that are similar to the acquired image;
receiving a selection of one of the items on sale; and
storing the acquired image as being associated with the selected item.

15. The method according to claim 14, further comprising:
receiving an input by a sales clerk that confirms that the selected item corresponds to the item to be purchased.

16. The method according to claim 14, further comprising:
receiving an input by a sales clerk to display the one or more items on sale,
wherein the one or more items on sale are displayed in response to the input.

17. The method according to claim 14, further comprising:
receiving a selection by the customer of one of the displayed items.

18. The method according to claim 17, further comprising:
notifying a sales clerk that the item selected by the customer is a predetermined item.

19. The method according to claim 17, wherein
the predetermined item is a discounted item.

20. The method according to claim 14, further comprising:
receiving a selection by a sales clerk of one of the displayed items.
